(19) United States
(12) Patent Application Publication
(10) Pub. No.: US 2014/0102641 A1
(43) Pub. Date: Apr. 17, 2014

(54) FIELD ENHANCED INDUCTIVELY COUPLED PLASMA PROCESSING APPARATUS AND PLASMA FORMING METHOD

(71) Applicant: SMATEK CO., LTD, Hwaseong-si (KR)

(72) Inventor: Soo-Hyun Lee, Hwaseong-si (KR)

(73) Assignee: SMATEK CO., LTD, Hwaseong-si (KR)

(21) Appl. No.: 13/649,694

(22) Filed: Oct. 11, 2012

(51) Int. Cl. H05H 1/46

(52) U.S. Cl. 156/345.37; 156/345.48; 315/111.21

(57) ABSTRACT

Disclosed herein is a field enhanced inductively coupled plasma processing apparatus including a process chamber having a dielectric lid, and a plasma source assembly disposed above the dielectric lid. The plasma source assembly includes at least one horizontal inductive coil configured to inductively couple RF energy into the process chamber to form and maintain plasma in the process chamber, at least one power applying electrode electrically connected to the horizontal inductive coil to capacitively couple the RF energy into the process chamber, a first positioning mechanism coupled to the power applying electrode to change a horizontal position of the power applying electrode, and an RF generator coupled to the at least one power applying electrode. The apparatus further includes a vertical inductive coil connected to the horizontal inductive coil, and a second positioning mechanism shifting an entire vertical position of the vertical inductive coil or changing the pitch thereof.

### BACKGROUND OF THE INVENTION

1. Field of the Invention

The present invention relates, in general, to semiconductor processing equipment and, more particularly, to an inductively coupled plasma processing apparatus and a plasma forming method.

2. Description of the Related Art

Generally, inductively coupled plasma (ICP) process reactors form plasma by inducing current into process gas disposed within a process chamber via one or more inductive coils disposed outside the process chamber. The inductive coils may be disposed externally and separated electrically from the chamber by, for example, a dielectric lid. For some of the plasma processes, a heater element may be disposed above the dielectric lid to make it easy to maintain a constant temperature in the chamber during a process and between processes.

The heater may be an open break heater (e.g. a non-closed electrical loop) or a no break heater (e.g. a closed electrical loop). In embodiments where the heater element is an open break heater element, the heater element introduces plasma non-uniformity that can result, for example, in non-uniform etching rates of a substrate which is to be processed or in asymmetry in an etching pattern. This plasma non-uniformity can be eliminated by replacing the open break heater element with the no break heater element.

### SUMMARY OF THE INVENTION

However, RF energy delivered to inductive coils is also inductively coupled to the no break heater element, so that energy available for forming plasma in a process chamber is undesirably reduced (e.g. the no break heater element reduces a plasma strike window).

Accordingly, there is a need for an improved inductively coupled plasma reactor.

The present invention provides a field enhanced inductively coupled plasma processing apparatus and a plasma forming method.

In an embodiment, a field enhanced inductively coupled plasma processing apparatus includes a process chamber having a dielectric lid, and a plasma source assembly disposed above the dielectric lid. The plasma source assembly includes at least one horizontal inductive coil configured to inductively couple RF energy into the process chamber to form and maintain plasma in the process chamber, at least one power applying electrode electrically connected to the horizontal inductive coil to capacitively couple the RF energy into the process chamber, a first positioning mechanism coupled to the power applying electrode to change a horizontal position of the power applying electrode, and an RF generator coupled to the at least one power applying electrode.

In an embodiment, the field enhanced inductively coupled plasma processing apparatus may further include a vertical inductive coil connected to the horizontal inductive coil and disposed on a side of the dielectric lid, and a second positioning mechanism that can change the entire vertical position of the vertical inductive coil or changes the pitch of the vertical inductive coil.

In an embodiment, a plasma forming method includes providing process gas to an internal volume of a process chamber, the process chamber having a dielectric lid and including at least one horizontal inductive coil disposed above the dielectric lid, at least one vertical inductive coil coupled to the horizontal inductive coil, and at least one power applying electrode electrically connected to the horizontal inductive coil; supplying RF power from an RF power source to the power applying electrode; forming plasma from the process gas using the RF power that is inductively coupled to the process gas by the horizontal and vertical inductive coils; and controlling at least one of plasma uniformity or ion density by changing at least one of a horizontal position of the power applying electrode, a pitch of the horizontal inductive coil, a position of the vertical inductive coil and a pitch of the vertical inductive coil.

Therefore, the present invention provides a field enhanced inductively coupled plasma reactor and a method of using the reactor. The field enhanced inductively coupled plasma reactor of the present invention may advantageously improve the available RF power for striking plasma in the chamber without changing other plasma characteristics, such as the plasma uniformity or ion density. The field enhanced inductively coupled plasma reactor of the present invention may further advantageously control and/or adjust plasma characteristics such as uniformity and/or density during processing.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic side view showing a field enhanced inductively coupled plasma reactor in accordance with an embodiment of the present invention;

FIG. 2 is a schematic plan view showing a horizontal inductive coil, a vertical inductive coil and a power applying electrode of the field enhanced inductively coupled plasma reactor in accordance with the embodiment of the present invention;

FIG. 3 is a schematic perspective view showing the horizontal inductive coil and the vertical inductive coil of the field enhanced inductively coupled plasma reactor in accordance with the embodiment of the present invention;

FIG. 4 is a schematic plan view showing a heater element of the field enhanced inductively coupled plasma reactor in accordance with the embodiment of the present invention; and

FIG. 5 is a flowchart showing a plasma forming method in accordance with an embodiment of the present invention.

### DESCRIPTION OF PREFERRED EMBODIMENTS

An inductively coupled plasma reactor according to the present invention may provide increased radio frequency (RF) energy used to strike plasma. For example, the plasma reactor provides an improved or enhanced plasma strike window. In addition, the inductively coupled plasma reactor according to the present invention advantageously provides excellent plasma strike capabilities without substantially altering the uniformity, density, or other desirable characteristics of the plasma.

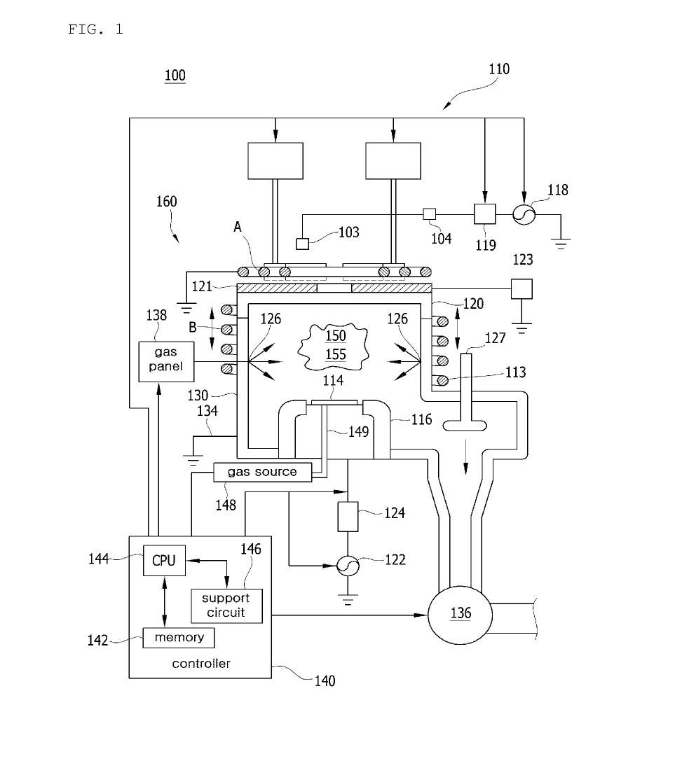

FIG. 1 is a side view schematically depicting a field enhanced inductively coupled plasma reactor 100 according to an embodiment of the present invention. The field enhanced inductively coupled plasma reactor 100 may be utilized alone as a processing module of an integrated semiconductor substrate processing system, or may utilize a cluster tool, such as a semiconductor wafer processing system. As a modification of the embodiment of the present invention, an inductively coupled plasma etching reactor is included. The above listing semiconductor equipment is merely illustrative, and other etching reactors, and non-etching reactors such as CVD reactors or other semiconductor processing equipment may be suitably modified.

The reactor 100 includes a process chamber 110 having a conductive body 130 and a dielectric lid 120 that define a processing volume together, a substrate support pedestal 116 disposed in the processing volume, and a plasma source assembly 160, and a controller 140. The conductive body 130 is coupled to an electrical ground 134. The support pedestal (cathode) 116 may be coupled, through a first matching network 124 to a biasing power source 122. The biasing power source 122 may illustratively be a power source of up to 1000 W at a frequency of about 13.56 MHz that is capable of producing either continuous or pulsed power, although other frequencies and power may be provided as desired for particular applications. According to another embodiment, the biasing power source 122 may be a DC or pulse-type DC power source.

In some embodiments, the dielectric lid 120 may be substantially flat. The lid of the field enhanced inductively coupled plasma reactor 100 may be a dome or may be in another shape. The plasma source assembly 160 is typically disposed above the dielectric lid 120 and is configured to inductively couple RF power into the process chamber 110. The plasma source assembly 160 includes one or more horizontal inductive coils, one or more vertical coils connected to the one or more horizontal inductive coils, one or more power applying electrodes, and a plasma power source. The one or more horizontal inductive coils may be disposed above the dielectric lid 120. The one or more vertical inductive coils may be disposed on a side of the dielectric lid 120 while being connected to the one or more horizontal inductive coils. As shown in FIG. 1, the one or more horizontal inductive coils 109 and 111 disposed above the dielectric lid 120 are illustratively shown.

For example, the multiple horizontal inductive coil 109 and 111 is spirally arranged. When one end of the first horizontal inductive coil 109 is on the left with respect to a center, the other end is on the right with respect to the center. When one end of the second horizontal inductive coil 111 is on the right with respect to the center, the other end is on the left with respect to the center. The horizontal inductive coils 109 and 111 are disposed to engage with each other while maintaining a predetermined interval therebetween. An interval between the first and second horizontal inductive coils, an interval between the vertical inductive coils, and the number of turns in each coil may be suitably selected to control the density or profile of the plasma, for example.

Each of the first and second horizontal inductive coils 109 and 111 is coupled by a matching network 119 to the plasma power source 118. Although other frequencies and power may be provided as desired for particular applications, the plasma power source 118 may illustratively produce up to 4000 W at a tunable frequency in a range from 50 kHz to 13.56 MHz.

In some embodiments, a power divider 104 may be provided between the one or more horizontal inductive coils to distribute the relative quantity of RF power provided by the plasma power source 118 to the respective coils through capacitor coupling. For example, as shown in FIG. 1, the power divider 104 may be disposed between power applying electrodes 102 and 103 connected to the plasma power source 118 and the first and second horizontal inductive coils 109 and 111 to control the quantity of RF power provided to each coil.

For example, the one or more power applying electrodes 102 and 103 are electrically coupled to the first horizontal inductive coil 109 or the second horizontal inductive coil 111, respectively, as shown in FIG. 1.

The RF power may be supplied from the plasma power source 118 via the one or more power applying electrodes 102 and 103 to the first horizontal inductive coil and the second horizontal inductive coil, respectively.

In some embodiments, the one or more power applying electrodes 102 and 103 may be movably coupled to one of the one or more horizontal inductive coils to facilitate their positioning relative to each other and/or to the dielectric lid 120. For example, one or more first positioning mechanisms (not shown) may be coupled to the one or more power applying electrodes 102 and 103 to change the horizontal position connected to the first horizontal inductive coil and the second horizontal inductive coil. The first positioning mechanism (not shown) may be any manual or automated device that can change the horizontal positioning, such as lead screws, linear bearings, stepper motors, wedges or the like.

In some embodiments, as shown in FIG. 1, a first positioning mechanism (not shown) may be coupled to each of the power applying electrodes 102 and 103 to independently control the horizontal position of each of the power applying electrodes 102 and 103.

In some embodiments, the first positioning mechanism (not shown) may be coupled to each of the first and second horizontal inductive coils 109 and 111 to change the pitch of the first and second horizontal inductive coils 109 and 111.

The independent control of the power applying electrodes for the horizontal position and/or the control of the pitch of the horizontal inductive coils facilitate the capacitive coupling of relative RF power, thus controlling the density of the plasma and/or the area of the plasma. For example, as the horizontal position of each power applying electrode is closer to the center of each coil, the density of the plasma is increased. Further, as the pitch of the horizontal inductive coils increases, the density of the plasma is reduced but the area of the plasma is increased.

The control of the quantity of the capacitive coupling of the RF power of the plasma source assembly 160 facilitates the control of the plasma characteristics in the chamber. For example, the capacitive coupling of the plasma source assembly 160 is controlled to change the plasma strike window while maintaining the desired characteristics of the inductively coupled plasma. The selective control for the pitch of the horizontal inductive coils or the position of the power applying electrodes allows sufficient capacitive coupling to facilitate striking the plasma without coupling much RF energy into the plasma once formed, thereby desirably changing the characteristics (e.g. density, dissociation fraction, ion/neutron ratio, etc.). Moreover, such a change further facilitates compensating for the process effects that may lead to non-uniform plasma such as non-uniform gas velocities in the chamber due to asymmetric gas delivery and/or pumping. For example, by increasing the capacitive coupling in regions of low plasma density relative to regions of higher plasma density, the overall plasma distribution in the chamber may be made more uniform, thereby facilitating more uniform processing.

The one or more electrodes of the plasma source assembly 160 may be symmetrically arranged above the dielectric lid 120 to promote uniform coupling of the RF energy to the plasma. In some embodiments, the one or more electrodes are configured such that they do not provide a continuous path that may cause current to be induced in the one or more electrodes. Hence, in the embodiment where a single electrode is utilized, the electrode may include a dielectric break such that the electrode does not form a conductive annular ring. However, such a particular break may lead to the non-uniformity of plasma due to the asymmetry of the configuration. When a single electrode is utilized, the dielectric break in the electrodes may be positioned to compensate for the natural plasma distribution in the chamber to correspond to the region of a relatively higher plasma density or proximate to the pump port of the chamber.

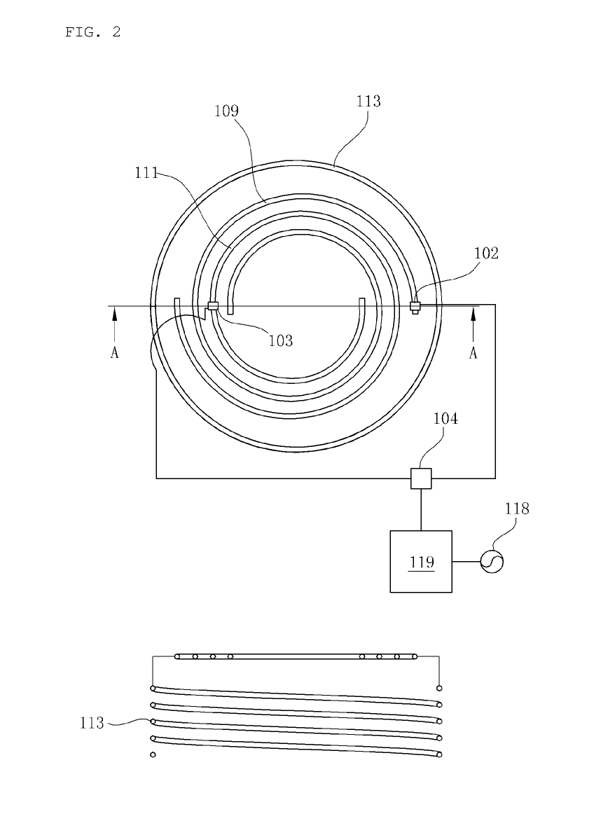

In some embodiments, two or more horizontal inductive coils 109 and 111 are disposed to engage with each other to symmetrically distribute any plasma effect caused by the dielectric space. For example, FIG. 2 is a schematic plan view showing two spiral horizontal inductive coils 109 and 111 spaced by a substantially uniform pitch and two power applying electrodes 102 and 103.

As shown in FIG. 1, at least one vertical inductive coil 113 is connected to at least one of the horizontal inductive coils 109 and 111. In some embodiments, the vertical inductive coil 113 may be shifted to an entirely different position in the vertical direction by a second positioning mechanism (not shown) or the pitch of the coil may be changed.

For example, the second positioning mechanism (not shown) may be a manual or automated device that may change the position or pitch of the vertical inductive coil 113, such as a lead screw, a linear bearing, a stepper motor or a wedge.

Meanwhile, For example, at least one power applying electrodes (not shown) are electrically coupled to the vertical inductive coil 113 respectively.

The RF power may be supplied from the plasma power source 118 via the one or more power applying electrodes to the vertical inductive coil 113.

In some embodiments, the one or more power applying electrodes may be movably coupled to the vertical inductive coil to facilitate their positioning relative to each other without the shift of the vertical inductive coil 113 and/or the change of the span between the vertical inductive coils 113. For example, the second positioning mechanisms may be coupled to the one or more power applying electrodes to change the vertical position connected to the vertical inductive coil.

Referring to FIG. 1, a heater element 121 may be disposed on the dielectric lid 120 to facilitate the heating in the process chamber 110. The heater element 121 may be disposed between the dielectric lid 120, the horizontal inductive coils 109 and 111 and the power applying electrodes 102 and 103. In some embodiments, the heater element 121 may include a resistive heating element and may be coupled to a power source 123, such as an AC power source that provides sufficient energy to control the temperature of the heater element 121 to be between about 50 and about 10° C. In some embodiments, the heater element 121 may be an open break heater. In some embodiments, the heater element 121 may include a no break heater, such as an annular element, thereby facilitating uniform plasma formation within the process chamber 110.

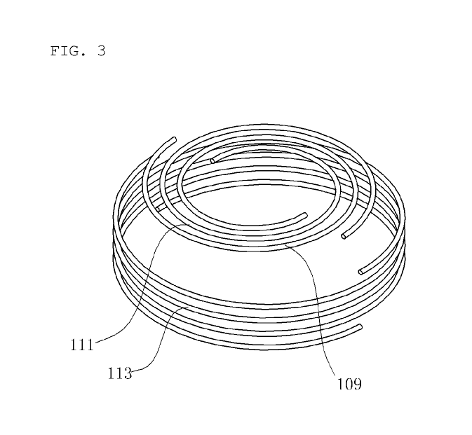

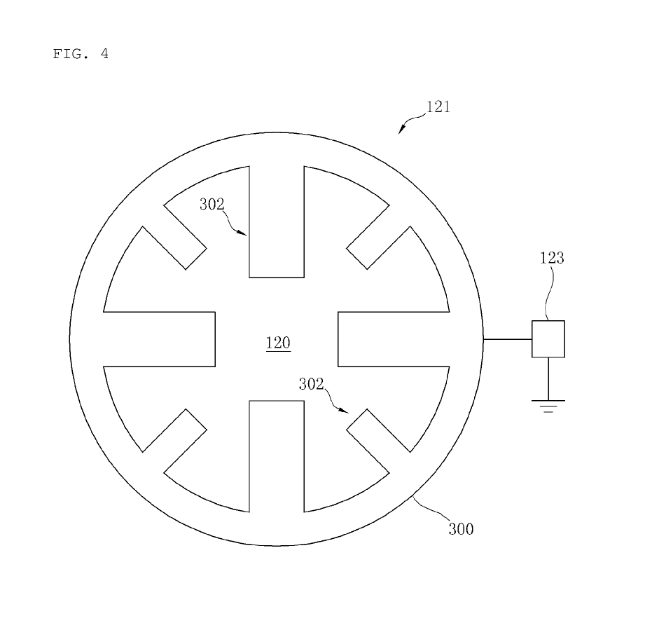

For example, FIG. 4 depicts a plan view of a heater element 121 in accordance with some embodiments of the present invention. The heater element 121 may include an annular portion 300 having fins 302 that extend inwards. In some embodiments, the annular portion 300 may be disposed along the periphery of the dielectric lid 120 as shown in FIGS. 1 and 3. For example, the annular portion 300 may have an outer diameter that is substantially equal to the outer diameter of the dielectric lid 120. In some embodiments, the outer diameter of the annular portion 300 may be greater or less than that of the dielectric lid 120. Other suitable configurations of the annular portion 300 may be utilized to allow the dielectric lid 120 to be heated in a substantially uniform manner. The fins 302 may be of any suitable width, length, or number about the annular portion 300 and/or position relative to the annular portion 300 to provide the desired quantity and distribution of heat to the process chamber 110. As shown in FIG. 3, the fins 302 may be arranged symmetrically about the annular portion 300 of the heater element 121 and may extend radially inwards therefrom.

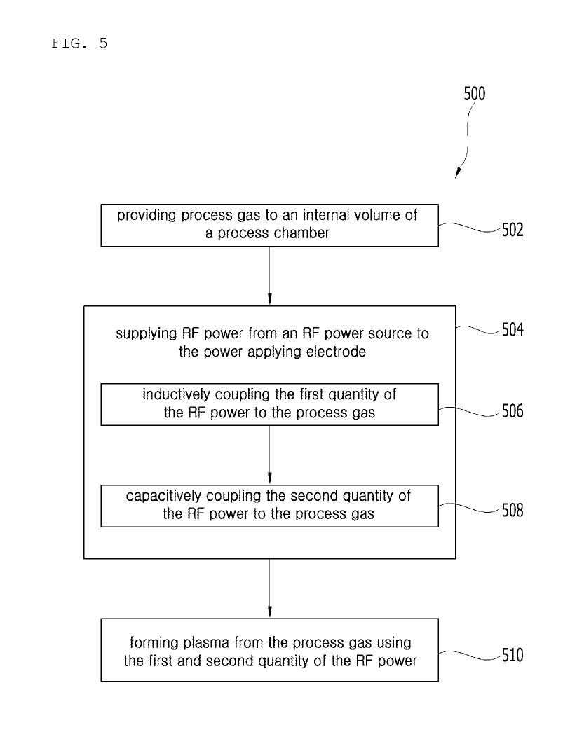

Referring to FIG. 1, during operation, a substrate 114 (such as a semiconductor wafer or other substrates suitable for plasma processing) may be disposed on the pedestal 116, and process gas may be supplied from a gas panel 138 through entry ports 126 to form a gaseous mixture in the process chamber 110. As discussed in more detail below with reference to FIG. 5, a gaseous mixture 150 may be ignited into plasma 155 in the process chamber 110 by supplying power from the plasma power source 118 to the horizontal inductive coils 109 and 111 and the vertical inductive coil 113. In some embodiments, power from a bias source 122 may also be provided to the pedestal 116. The pressure in the process chamber 110 may be controlled using a throttle valve 127 and a vacuum pump 136. The temperature of the conductive body 130 may be controlled using conduits (not shown) that run through the conductive body 130.

The temperature of the wafer 114 may be controlled by stabilizing the temperature of the support pedestal 116. In one embodiment, helium gas from a gas source 148 may be provided via a gas conduit 149 to channels defined between the backside of the wafer 114 and grooves (not shown) disposed on the surface of the pedestal. The helium gas is used to facilitate heat transfer between the pedestal 116 and the wafer 114. During processing, the support pedestal 116 may be heated by a resistive heater (not shown) to a steady state temperature and the helium gas may facilitate uniform heating of the wafer 114. Using such thermal control, the wafer 114 may illustratively be maintained at a temperature between 0° C. and 500° C.

The controller 140 includes a central processing unit (CPU) 144, a memory 142, and support circuits 146 for the CPU 144, and facilitates the control of the components of the reactor 100 and of the method of forming plasma. The controller 140 may be used in an industrial setting for controlling various chambers and sub-processors. The memory or computer-readable medium of the CPU 144 may be one or more readily available memory such as a random access memory (RAM), a read only memory (ROM), a floppy disk, a hard disk, or any other form of local or remote digital storage. The support circuits 146 are coupled to the CPU 144 for supporting the processor in a conventional manner. These circuits include cache, power supplies, clock circuits, input/output circuitry and sub-systems and the like. The inventive method may be stored in the memory 142 as a software routine that may be executed or invoked to control the operation of the plasma reactor 100 in a manner that will be described below. The software routine may also be stored and/or executed by a second CPU (not shown) that is remotely located from the hardware controlled by the CPU 144.

FIG. 5 depicts a method 500 of forming plasma in a field enhanced inductively coupled reactor, similar to the above-mentioned plasma reactor 100, in accordance with an embodiment of the present invention. The method generally begins at step 502, where process gas (or gases) is provided to the process chamber 110. The process gas or gases may be supplied from the gas panel 138 through the entry ports 126, and form the gaseous mixture 150 in the chamber 110. The chamber components, such as the conductive body 130, the dielectric lid 120 and the support pedestal 116, may be heated as described above to the desired temperature before or after the process gas is provided.

The dielectric lid 120 may be heated by supplying power from the power source 123 to the heater element 121. The supplied power may be controlled to maintain the process chamber 110 at the desired temperature during processing.

Next, at step 504, RF power from the RF power source 118 may be provided to the horizontal and vertical inductive coils to be respectively inductively and capacitively coupled to the process gas mixture 150. The RF power may illustratively be provided at up to 4000 W and at a tunable frequency in a range from 50 kHz to 13.56 MHz, although other power and frequencies may be utilized to form the plasma.

In some embodiments, a first quantity of RF power may be inductively coupled to the process gas via the horizontal and vertical inductive coils, at step 506. The first quantity of RF power applied to the horizontal inductive coil 109 may be undesirably reduced by the presence of a no break heating element (e.g. embodiments where heater element 121 is a no break heating element) due to a portion of the first quantity of RF power inductively coupled into the heater element 121, thereby undesirably making it more difficult to strike plasma. However, when a second quantity of RF power applied to the horizontal inductive coil 111 is not reduced by being capacitively coupled into the process gas and inductively coupled to the heater element 121, in step 508, the second quantity of RF plasma improves the ability to strike plasma under a wider range of conditions.

In step 510, the plasma 155 is formed from the process gas mixture 150 using the first and second quantities of RF power provided by the horizontal inductive coils 109 and 111 and the vertical inductive coil, respectively. Upon striking the plasma and obtaining plasma stabilization, the method 500 is generally ended and plasma processing may be continued as desired. For example, the process may continue, at least in part, using the RF power settings and other processing parameters per standard process recipe. Alternatively or in combination, the power applying electrodes 102 and 103 connected to the horizontal moving coils may move horizontally or may change a pitch of the horizontal moving coils to change the capacitive coupling of the RF power into the process chamber during processing, and the vertical position of the vertical moving coils or the pitch of the vertical moving coils may be changed to vary the capacitive coupling of the RF power into the process chamber 110.

Therefore, the present invention provides a field enhanced inductively coupled plasma reactor and a method of using the reactor. The field enhanced inductively coupled plasma reactor of the present invention may advantageously improve the available RF power for striking plasma in the chamber without changing other plasma characteristics, such as plasma uniformity or ion density. The field enhanced inductively coupled plasma reactor of the present invention may further advantageously control and/or adjust plasma characteristics such as uniformity and/or density during processing.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A field enhanced inductively coupled plasma processing apparatus, comprising:
a process chamber having a dielectric lid; and
a plasma source assembly disposed above the dielectric lid, the plasma source assembly comprising:
at least one horizontal inductive coil configured to inductively couple RF energy into the process chamber to form and maintain plasma in the process chamber;
at least one first power applying electrode electrically connected to the horizontal inductive coil to capacitively couple the RF energy into the process chamber;
a first positioning mechanism coupled to the first power applying electrode to change a horizontal position of the power applying electrode; and
an RF generator coupled to the at least one power applying electrode.

2. The field enhanced inductively coupled plasma processing apparatus as set forth in claim 1, wherein the first positioning mechanism is coupled to the horizontal inductive coil to change a pitch of the horizontal inductive coil.

3. The field enhanced inductively coupled plasma processing apparatus as set forth in claim 1, wherein the horizontal inductive coil comprises:
a first horizontal inductive coil having a spiral shape, a first end thereof being located to a left with respect to a center, a second end thereof being located to a right with respect to the center; and
a second horizontal inductive coil having a spiral shape, a first end thereof being located to a right with respect to a center, a second end thereof being located to a left with respect to the center.

4. The field enhanced inductively coupled plasma processing apparatus as set forth in claim 3, further comprising:
a power divider distributing a relative quantity of the RF power provided to the first and second horizontal inductive coils by capacitor coupling.

5. The field enhanced inductively coupled plasma processing apparatus as set forth in any one of claims 1, further comprising:
a vertical inductive coil disposed on a side of the dielectric lid.

6. The field enhanced inductively coupled plasma processing apparatus as set forth in claim 5, further comprising:
a second positioning mechanism shifting an entire vertical position of the vertical inductive coil or changing a pitch of the vertical inductive coil.

7. The field enhanced inductively coupled plasma processing apparatus as set forth in claim 6, wherein each of the first and second positioning mechanisms comprises at least one of a lead screw, a linear bearing, a stepper motor and a wedge.

8. The field enhanced inductively coupled plasma processing apparatus as set forth in claim 5, further comprising:
a second power applying electrode connected to the vertical inductive coil.

9. The field enhanced inductively coupled plasma processing apparatus as set forth in claim 8, further comprising:
a second positioning mechanism coupled to the second power applying electrode to change a vertical position of the second power applying electrode.

10. The field enhanced inductively coupled plasma processing apparatus as set forth in claim 9, wherein the second positioning mechanisms comprises at least one of a lead screw, a linear bearing, a stepper motor and a wedge.

11. The field enhanced inductively coupled plasma processing apparatus as set forth in any one of claims 1, further comprising:
a heater element disposed between the power applying electrode of the plasma source assembly and the dielectric lid.

12. A plasma forming method, comprising:
providing process gas to an internal volume of a process chamber, the process chamber having a dielectric lid and including at least one horizontal inductive coil disposed above the dielectric lid, at least one vertical inductive coil coupled to the horizontal inductive coil, and at least one power applying electrode electrically connected to the horizontal inductive coil;
supplying RF power from an RF power source to the power applying electrode;
forming plasma from the process gas using the RF power that is inductively coupled to the process gas by the horizontal and vertical inductive coils; and
controlling at least one of plasma uniformity or ion density by changing at least one of a horizontal position of the power applying electrode, a pitch of the horizontal inductive coil, a position of the vertical inductive coil and a pitch of the vertical inductive coil.

13. The plasma forming method as set forth in claim 12, wherein the process chamber further comprises a heater element disposed above the dielectric lid, the method further comprising supplying power to the heater element to control a temperature of the process chamber.
